(19) United States
(12) Patent Application Publication
(10) Pub. No.: US 2011/0025043 A1
(43) Pub. Date: Feb. 3, 2011

(54) FLUID LINE COUPLING

(75) Inventors: Pierrick Garnier, Saint Marcel Les Valence (FR); Albert Raymond, Claix (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/671,559

(22) PCT Filed: Jul. 10, 2008
(86) PCT No.: PCT/EP08/05618

§ 371 Date: Feb. 1, 2010

(30) Foreign Application Priority Data
Aug. 2, 2007 (DE) 10 2007 036 533.2

(51) Int. Cl. F16L 53/00

(52) U.S. Cl. 285/41

(57) ABSTRACT

In a fluid line coupling, there is an electrically heatable heating element (14) in order to heat a fluid flowing in a fluid line cavity (7), said heating element being held with an axial prestress against sealing means (21) by a securing means (22) in a connecting part (8) of a coupling body (1) of the fluid line coupling. As a result, a high degree of tightness is obtained.

### CROSS-REFERENCE TO RELATED APPLICATION

This application is a U.S. National Phase Patent Application based on International Application Serial No. PCT/EP2008/005618 filed Jul. 10, 2008, the disclosure of which is hereby explicitly incorporated by reference herein.

### BACKGROUND OF THE INVENTION

1. Field of the Invention

The present invention relates to a fluid line coupling.

2. Description of the Related Art

One fluid line coupling is known, for example, from DE 43 00 037 C1. The prior fluid line coupling is provided with a coupling body having a connector for a line of a fluid line arrangement, and is equipped with a receiving part configured to receive a plug-in part that is connected to another line of the fluid line arrangement. Extending between the connector and the receiving part is a fluid line cavity through which a fluid flows in the installed situation, i.e., that of being integrated into the fluid line arrangement.

Known from JP 2006-125480 is a line connection arrangement comprising a tubular, bent heating wire that is fitted to the contour of a sealing unit.

### SUMMARY OF THE INVENTION

The invention provides a fluid line coupling that ensures the reliable passage of a fluid flowing through the fluid line coupling, even at relatively low temperatures.

By virtue of the fact that the fluid line coupling according to the invention comprises an electrically heatable heating element that is inserted in the connecting part and is coupled in a fluid-tight manner via the sealing means, a fluid flowing in the fluid line cavity can be heated very efficiently over the relatively large-area contact region that is in thermodynamic contact with the fluid line cavity.

In one form thereof, the present invention provides a fluid line coupling provided with a coupling body that has a connector for a line of a fluid line arrangement and is equipped with a receiving part configured to receive a plug-in part that is connected to another line of the fluid line arrangement, wherein a fluid line cavity extends between the connector and the receiving part, characterized in that configured on the coupling body is a sleeve-like connecting part that is open to the outside and that gives into the fluid line cavity, in that a heating element that can be heated by electric power is present and can be inserted into the connecting part and has a contact region which in the inserted arrangement of the heating element forms a wall region of the fluid line cavity, in that a sealing unit is present and is disposed between the connecting part and the heating element, and in that securing means are present and hold the heating element fluid-tightly in the connecting part.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a partially sectional side view of a first exemplary embodiment of a fluid line coupling according to the invention, with a heating element having a flat fluid-contact surface;

FIG. 2 is a sectional detail view of another exemplary embodiment of a fluid line coupling according to the invention, with a heating element comprising a fluid-contact sleeve; and

FIG. 3 is a sectional detail view of another exemplary embodiment of a fluid line coupling according to the invention, with a heating element comprising a fluid-contact mandrel and with a thermally insulating intermediate element.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

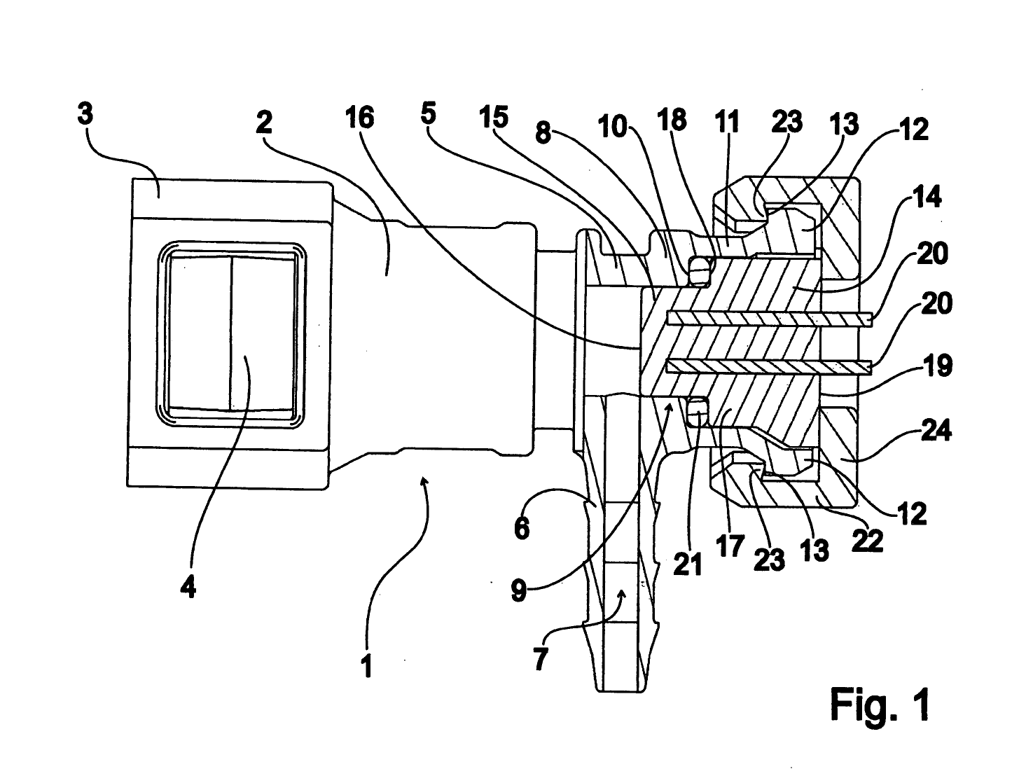

FIG. 1 is a partially sectional side view of an exemplary embodiment of a fluid line coupling according to the invention, comprising a coupling body 1 made of a hard elastic synthetic material. The coupling body 1 comprises a substantially cylindrical receiving part 2, which is configured to receive a plug-in part (not shown in FIG. 1) to which a line of a fluid line arrangement (also not shown in FIG. 1) can be connected by means of the fluid line coupling. To connect the plug-in part to the coupling body 1, formed at one end of the receiving part 2 is an approximately square socket 3 for a locking part 4 that is to be inserted in said socket 3.

At the end of receiving part 2 facing away from socket 3, attached, as a connector, at a bracket portion 5 is a connection fitting 6, to which can be connected another line (not shown in FIG. 1) of the fluid line arrangement that is then fluidically connected, via a fluid line cavity 7 extending through the coupling body 1, to the line that is connected to the plug-in part inserted in the receiving part 2.

Configured on the coupling body 1 at the opposite end of bracket portion 5 from receiving part 2 and in axial prolongation of receiving part 2 is a sleeve-like connecting part 8, which, on the one hand, opens by a cylindrical mouth portion 9 into the fluid line cavity 7, and, on the other hand, is open to the outside in the direction pointing away from fluid line cavity 7. On the radially inward-facing inner face, connecting part 8 presents an abutment shoulder 10, which extends from mouth portion 9 radially outward perpendicularly to the longitudinal axis of connecting part 8. From the abutment shoulder 10, a cylindrical socket portion 11 extends axially outward away from mouth portion 9, and has attached to its end spring arms 12 that extend in the longitudinal direction of connecting part 8 and are elastic in the radial direction. Each spring arm 12 has, formed at its end directed away from socket portion 11, a respective snap nose 13 that extends outward in the radial direction.

The fluid line coupling according to the invention is also equipped with a heating element 14, which is made from a synthetic material that is electrically conductive, for example due to the addition of carbon particles or metal particles, and has a positive temperature coefficient. In the representation according to FIG. 1, heating element 14 is inserted in connecting part 8 and comprises frontally a first cylinder portion 15, which is disposed flush in mouth portion 9 and forms, in the region of bracket portion 5, a wall region of the fluid line cavity 7 in the form of a frontal, flat, fluid-contact surface 16 that faces toward receiving part 2 and serves as a large-area thermodynamic contact region.

Heating element 14 also comprises, joined to first cylinder portion 15 on the side facing away from fluid-contact surface 16, a second cylinder portion 17 with a larger diameter than first cylinder portion 15, with the result that a pressure shoulder 18, disposed opposite abutment shoulder 10, is formed between first cylinder portion 15 and second cylinder portion 17. Second cylinder portion 17 is inserted flush into socket portion 11 and protrudes axially outward beyond the spring arms 12 by a pressure face 19 that is oriented perpendicular to the longitudinal axis of connecting part 8.

Embedded in heating element 14 in this exemplary embodiment are two metal connector pins 20, which extend from first cylinder portion 15 all the way through second cylinder portion 17 to protrude outward beyond pressure face 19. The connector pins 20 are connected to an electric power supply (not shown in FIG. 1) by means of which an electrical current can be fed to the connector pins 20 to effect direct proportional heating of the heating element 14 by virtue of the positive temperature coefficient of said heating element 14.

In the assembled arrangement of coupling body 1 and heating element 14, disposed as a sealing unit between abutment shoulder 10 and pressure shoulder 18 is an annular, closed sealing ring 21 made of a soft elastic material, which surrounds the first cylinder portion 15 of heating element 14 and bears by its outer face against the inner wall of socket portion 11, said sealing ring 21 being biased in the radial direction in this arrangement.

The fluid line coupling according to the invention is further provided with securing means comprising a securing ring 22 made of a hard elastic material, which in the assembled arrangement of the fluid line coupling outwardly surrounds connecting part 8. Securing ring 22 is provided, on its side that faces toward receiving part 2 in the assembled arrangement, with a snap collar 23, which extends radially inwardly and in the assembled arrangement according to FIG. 1 engages behind the snap noses 13, thereby securing the securing ring 22 against axial displacement away from coupling body 1. Securing ring 22 also has, on its opposite side from snap collar 23, a pressure collar 24, which also extends radially inwardly and in the assembled arrangement of the fluid line coupling bears outwardly, in this exemplary embodiment, against the pressure face 19 of heating element 14. The dimensions of heating element 14 and of securing ring 22 in this case are so adapted to one another in the longitudinal direction that in the assembled arrangement of the fluid line coupling, the heating element 14 is pressed against the sealing ring 22 with a certain axial pressure force.

Sealing ring 21 is thereby subjected to an axial pressure force in addition to the radial pressure force, thus substantially increasing the sealing effect. This is highly advantageous particularly since, despite the reduction of the mechanical strength of the heating element 14 that occurs with increasing heating, the high sealing effect is nevertheless substantially maintained by the continual axial pressure of sealing ring 21 against abutment shoulder 10 and against pressure shoulder 18 that is induced by securing ring 22.

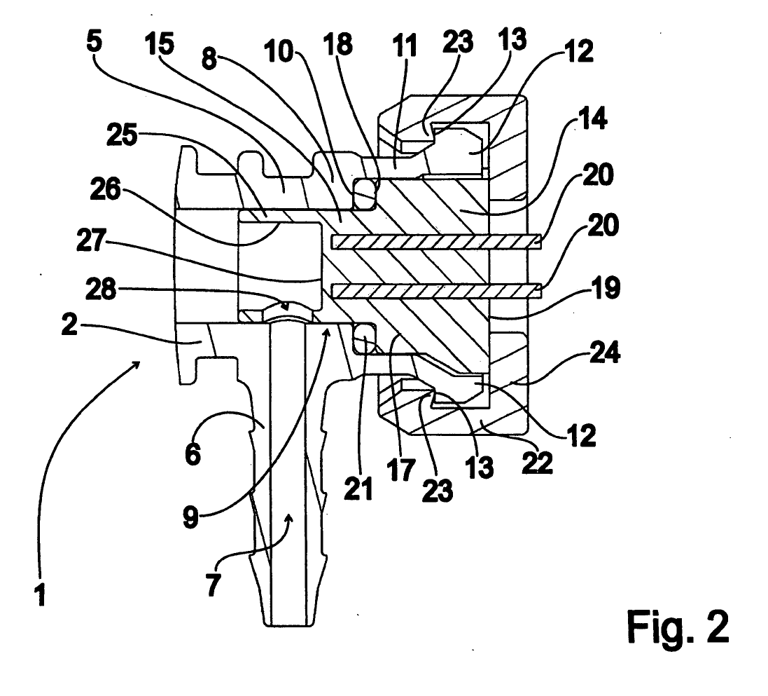

FIG. 2 is a sectional detail view of another exemplary embodiment of a fluid line coupling according to the invention in the region of connecting part 8, it being noted that like elements in the exemplary embodiments according to FIG. 1 and FIG. 2 are provided with the same reference numerals and will not be described more closely below. In the exemplary embodiment according to FIG. 2, to create a thermodynamic contact region, heating element 14 is configured with a hollow-cylinder-like fluid-contact sleeve 25, which is formed onto the end of first cylinder portion 15 that is directed away from second cylinder portion 17. In the region of bracket portion 5, fluid-contact sleeve 25 abuts the inner wall of fluid line cavity 7, with the result that the radially inward-facing inner wall 26 of fluid-contact sleeve 25, as the interior wall, together with a flat end wall 27 that extends between the fluid-contact sleeve 25 and is configured at the end of first cylinder portion 15 that faces toward fluid line cavity 7, forms the entire, very large-area thermodynamic contact region.

To enable fluid to flow through the fluid line coupling, fluid-contact sleeve 25 is pierced by a penetrating opening 28 in the region of the connection of connection fitting 6 to bracket portion 5. Alignment means (not shown in FIG. 2) formed on coupling body 1 and on heating element 14 serve to ensure that penetrating opening 28 is disposed in the connection region of connection fitting 6 when securing ring 22 engages behind snap noses 13.

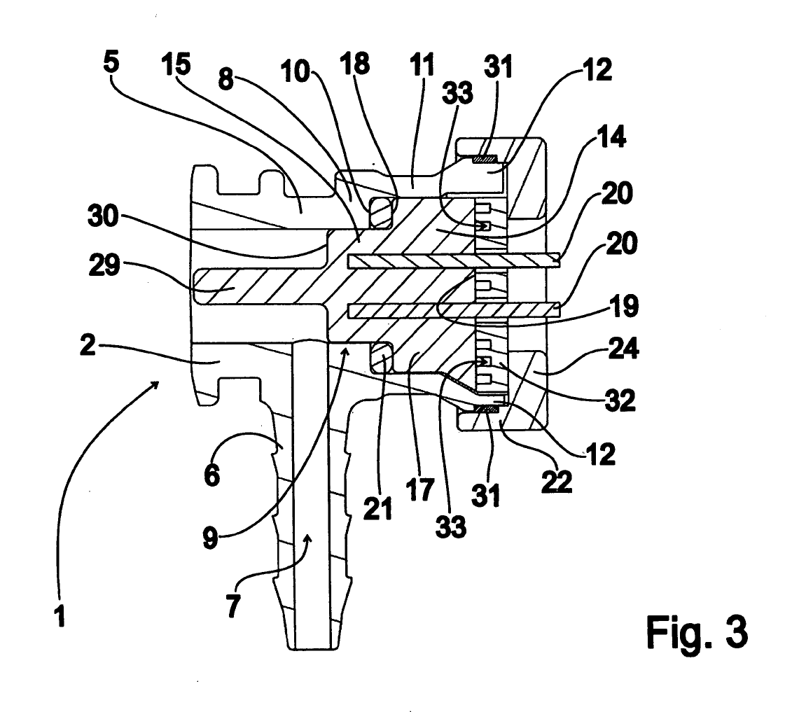

FIG. 3 is a sectional detail view of another exemplary embodiment of a fluid line coupling according to the invention in the region of connecting part 8, it being noted that like elements in the exemplary embodiments according to FIG. 1, FIG. 2 and FIG. 3 are provided with the same reference numerals and will not be described more closely below. In the exemplary embodiment according to FIG. 3, a thermodynamic contact region of heating element 14 is formed by a solid, cylinder-like fluid-contact mandrel 29, which is disposed on the end face of first cylinder portion 15 facing toward receiving part 2 and is situated centrally and spaced away from the inner face of fluid line cavity 7, and by a flat fluid-contact marginal area 30 outwardly surrounding fluid-contact mandrel 29. A very large-area contact region is also formed in this way.

In the exemplary embodiment depicted in FIG. 3, in deviation from the previously described exemplary embodiments, the securing ring 22 is attached to connecting part 8 by a weld joint 31.

Additionally, in the exemplary embodiment according to FIG. 3, disposed between the heating element 14 and the pressure collar 24 of securing ring 22 is an intermediate element 32 in the form of a flat plate made from a low-thermal-conductivity, hard-elastic synthetic material, in order to thermally insulate heating element 14 from securing ring 22 and thus ensure the persistence of the axial bias, even over very long periods of time spanning numerous heating cycles. With a view toward especially good thermal insulation, the intermediate element 32 is configured, on its side facing toward heating element 14, with a number of insulating cavities 33 that are open to heating element 14 and reduce heat transfer to the securing ring 22 compared to a completely solid embodiment.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A fluid line coupling for use in connecting lines of a fluid line arrangement, comprising:
a coupling body, comprising:
a connector configured to connect to a line of the fluid line arrangement;
a receiving part configured to connect to another line of the fluid line arrangement;
a fluid line cavity extending between and fluidly communicating said connector and said receiving part; and
a connecting part disposed along an axial direction, said connecting part open to an outside of said coupling body and in communication with said fluid line cavity;
a heating element heatable by electric power, said heating element inserted into said connecting part and including a contact region forming a wall region of said fluid line cavity;
a sealing unit disposed between said connecting part and said heating element; and
a securing element attached to said connecting part, said securing element holding said heating element fluid-tightly within said connecting part.

11. The fluid line coupling of claim 10, wherein said securing element includes a securing ring disposed externally on said connecting part, said securing ring biasing said heating element in said axial direction.

12. The fluid line coupling of claim 11, wherein said heating element is made of a conductive synthetic material having a positive temperature coefficient.

13. The fluid line coupling of claim 10, wherein said contact region includes a flat fluid contact surface.

14. The fluid line coupling of claim 10, wherein said contact region includes a cylindrical fluid contact sleeve having an end wall.

15. The fluid line coupling of claim 10, wherein said contact region includes a centrally disposed, protruding fluid contact mandrel and a fluid contact marginal area surrounding said fluid-contact mandrel.

16. The fluid line coupling of claim 11, further comprising a thermally insulating intermediate element disposed between said heating element and said securing ring.

17. The fluid line coupling of claim 16, wherein said intermediate element is a flat plate.

18. The fluid line coupling of claim 17, wherein said intermediate element includes a plurality of insulating cavities open to said heating element.

19. The fluid line coupling of claim 10, wherein said receiving part is configured to receive a plug-in part that is connected to the other line of the fluid line arrangement.
